(19) United States
(12) Patent Application Publication
(10) Pub. No.: US 2024/0262121 A1
(43) Pub. Date: Aug. 8, 2024

(54) METHOD FOR MANUFACTURING INKJET PRINTABLE PAPER FOR USE AS A DÉCOR PAPER

(71) Applicants: Flooring Industries Limited, SARL, Bertrange (LU); Interprint GmbH, Arnsberg (DE)

(72) Inventors: Robert DAVID, Soest (DE); Malte TADDAY, Arnsberg (DE)

(73) Assignees: Flooring Industries Limited, SARL, Bertrange (LU); Interprint GmbH, Arnsberg (DE)

(21) Appl. No.: 18/561,228

(22) PCT Filed: May 16, 2022
(86) PCT No.: PCT/IB2022/054533

§ 371 Date: Nov. 15, 2023

(30) Foreign Application Priority Data
May 18, 2021 (EP) 21174381.0

(51) Int. Cl. B41M 5/52; B44C 5/04

(52) U.S. Cl. CPC B41M 5/5218; B41M 5/5254; B41M 5/5272; B41M 5/5281; B44C 5/04

(57) ABSTRACT

A method is provided for manufacturing paper printable with an inkjet printer and/or analog printing, preferably gravure printing for use as a decor paper in a laminate panel. The method may involve providing a paper layer and coating at least one side of the paper layer with an ink receiver coating. The method may also involve providing the paper layer with an ink adhesion promoter.

This application claims priority under 35 USC § 119(a)-(d) from EP patent application number 21174381.0, which was filed on May 18, 2021, the entire content of which is incorporated herein by reference.

### BACKGROUND

### 1. Field

The present invention relates to a method for manufacturing panels having a decorative surface, or, so-called decorative panels. The invention also relates to a method for manufacturing paper printable with inkjet for use as a decor paper in such panels and to the paper obtainable with such method. The invention further relates to a printed décor paper to be used in such panel and to a method for manufacturing such paper. According to a variant the obtained decor paper may be used in a laminated assembly other than a panel, such as in so-called CPL (compact laminate) or HPL (high pressure laminate).

More particularly the invention is related to a method for manufacturing laminate panels, wherein said panels at least comprise a substrate material and a provided thereon top layer with a printed decor. The top layer is formed from thermosetting resin and one or more paper layers, wherein said paper layers comprise a decor paper having a printed pattern. The panels of the invention may relate to furniture panels, ceiling panels, flooring panels or similar, wherein these panels preferably comprise a wood-based substrate, such as an MDF or HDF substrate (Medium or High Density Fiberboard) or a substrate material consisting of or essentially made of wood particleboard

### 2. Related Art

Traditionally, the decor or pattern of such panels is printed on paper by means of rotogravure printing. The obtained paper is taken up as a decorative paper in a so-called laminate panel. For manufacturing the panels of the above mentioned first possibility the DPL process can be practiced. According to the DPL process (Direct Pressure Laminate) the already printed paper or decorative paper is provided with melamine resin to form a decorative layer. Afterwards a stack is formed comprising at least a plate shaped substrate, said decorative layer and possibly a protective layer on top of said decorative layer, wherein said protective layer or overlay is based on resin and/or paper as well. Said stack is pressed and the press treatment results in a mutual connection or adherence of the decorative paper, the substrate and the protective layer, as well as in a hardening of the resin present in the stack. As a result of the pressing operation a decorative panel is obtained having a melamine surface, which can be highly wear resistant. At the bottom side of the plate shaped substrate a counter layer or balancing layer can be applied, or as an alternative a decorative layer might be attached to the bottom side as well, especially in the case of laminate panels for furniture. Such a counter layer or balancing layer or any other layer at the bottom side of the laminate panel restricts or prevents possible bending of the decorative panel, and is applied in the same press treatment, for example by the provision of a resin carrying paper layer as the lowermost layer of the stack, at the side of the stack opposite said decorative layer. For examples of a DPL process reference is made to EP 1 290 290, from which it is further known to provide a relief in said melamine surface during the same press treatment or pressing operation, namely by bringing said melamine surface in contact with a structured press element, for example a structured press plate.

Instead of analog printing techniques, digital printing techniques, especially inkjet printing techniques, are becoming increasingly popular for the creation of decors or patterns, be it on paper or directly on a plate-shaped substrate possibly with the intermediary of preparatory layers. Such digital techniques can enhance the flexibility in the printing of decors significantly. Reference is amongst others made to the EP 1 872 959, WO 2011/124503, EP 1 857 511, EP 2 431 190, EP 2 293 946, WO 2014/084787, WO 2015/140682 and the WO 2015/118451, where such techniques are disclosed.

As mentioned above, before being laminated onto the substrate, the printed décor paper is impregnated with a resin, via immersion in a bath of said resin. The impregnation can cause bleeding of the ink in the bath thereby deteriorating the quality of the décor paper. The bleeding of the ink may further cause contamination of the bath and of décor paper subsequently impregnated in the contaminated bath.

EP 2 132 041 discloses a method at least comprising the step of providing a paper layer with thermosetting resin before said step of providing said resin provided paper layer with at least a portion of said digital printed pattern. It has however been very difficult to reliably further process such printed paper for manufacturing laminate panels, such as in a DPL process, since pressing defects may originate in the resin surface and milling, drilling or sawing through the laminate surface or at the edge thereof often leads to splitting in the top layer. Furthermore, the inks or dyes of the EP′041 may overly wet the paper layer and cause wrinkling effects or bleeding upon further handling of the printed paper, leading to an instable and/or slow production process. To solve this issue the EP′041 propose to immediately dry the printed paper layer.

### SUMMARY

The present invention aims in the first place at an alternative method for manufacturing panels having a decorative surface or paper, for use in such panels, and seeks, in accordance with several of its preferred embodiments, to solve one or more of the problems arising in the state of the art.

Therefore, the present invention, in accordance with its first independent aspect, relates to a method for manufacturing paper printable with an inkjet printer and/or analog printing, preferably gravure printing for use as a decor paper, in a laminate panel, wherein the method at least comprises the following steps:
the step of providing a paper layer;
the step of coating at least one side of said paper layer with an ink receiver coating; with as a characteristic that said the method comprises the step of providing said paper with an ink adhesion promoter. The inventors have found that such adhesion promoter can substantially reduce the risk of bleeding of the ink thereby improving the quality of the décor paper after impregnation. Preferably, said ink adhesion promoter is provided in the ink receiver layer, for example it can be part of the ink receiver layer composition. Moreover, by including the adhesion promoter in the ink receiver layer it is not necessary to perform an extra step in the manufacturing process.

Preferably, said ink adhesion promoter comprises a urea-based promoter, a polyurethane-based promoter, a casein-based promoter, an acrylic based promoter and/or a mixture thereof. Inventors have found that these substances may significantly improve the adhesion of the ink to the paper and preferably to ink receiver coating during impregnation of the paper. The inventor has found that the adhesion of the ink can be significantly improved if said ink adhesion promoter is selected on the basis of the ink to be printed, in particular if the ink adhesion promoter is substantially the same of a binder comprised in said ink. With substantially the same it is meant that the ink adhesion promoter can be the same substance of the binder of the ink, or can belong the same family of substances. Preferred example of the adhesion ink adhesion promoter can comprise urea-based promoter, polyurethane-based promoter, casein-based promoter, styrene-based promoter, polyester-based promoter, polyvinyl-based promoter, alkyd-based promoter, ketone-based promoter, melamine-based promoter, silicone-based promoter, cellulose-based promoter, gum-based promoter, acrylic-based promoter or a mixture or copolymer thereof.

In the preferred embodiment, the ink adhesion promoter is provided in an amount above 0.2 g/sqm, more preferably above 0.5 g/sqm, even more preferably above 1 g/sqm. Said minimum amount have been found ideal to maximize adhesion of the ink in the paper when said quantity of ink is up to 15 milliliter per square meter XXXXX g/sqm. It may also be preferable that the ink adhesion promoter is provided in an amount below 10 g/sqm, more preferably below 5 g/sqm. Said maximum amount has been found ideal for maximizing the adhesion effect without affecting the performances of the ink receiver layer.

Said ink receiver layer can comprise pigments. In the preferred example, for the pigment at least or mainly silica particles are used. Preferably the silica particles are silane treated. Silane treatment of the pigments, in general, enhances dust release properties of the attained ink receiver layer and the thus treated paper or thermoplastic foil. The silane treatment may relate to a treatment with a coupling agent such as amino-organo-silanes, hydroxysilanes, dipodal silanes and/or other silanes. Preferably, the coupling agent is chosen such that the risk of yellowing upon aging of the attained ink receiver layer is low. Preferably, the coupling agent forms 0.1 to 10% of the total wet weight of the ink receiver layer.

According to variants, for the pigment of said ink receiver layer at least or mainly particles are used chosen from the list consisting of calcium carbonate, alumina, aluminosilicates, ordered mesoporous materials, modified silica, organosilica, modified organosilica, organoalumina, modified alumina, aluminates, modified aluminates, organoaluminates, modified organoaluminates, zeolites, metal organic frameworks and porous polar polymers.

Preferably said pigment has a BET surface area between 10 and 1600 m²/g, and preferably between 15 and 500 m²/g.

The ink receiver layer preferably comprises a binder. In the preferred embodiment for the binder at least or mainly polyvinyl alcohols are used.

According to variants, the ink receiver coating includes, as a binder, a polymer selected from the group consisting of hydroxyethyl cellulose; hydroxypropyl cellulose; hydroxyethylmethyl cellulose; hydroxypropyl methyl cellulose; hydroxybutylmethyl cellulose; methyl cellulose; sodium carboxymethyl cellulose; sodium carboxymethylhydroxethyl cellulose; water soluble ethylhydroxyethyl cellulose; cellulose sulfate; vinylalcohol copolymers; polyvinyl acetate; polyvinyl acetal; polyvinyl pyrrolidone; polyacrylamide; acrylamide/acrylic acid copolymer; polystyrene, styrene copolymers; acrylic or methacrylic polymers; styrene/acrylic copolymers; ethylene-vinylacetate copolymer; vinyl-methyl ether/maleic acid copolymer; poly(2-acrylamido-2-methyl propane sulfonic acid); poly(diethylene triamine-co-adipic acid); polyvinyl pyridine; polyvinyl imidazole; polyethylene imine epichlorohydrin modified; polyethylene imine ethoxylated; ether bond-containing polymers such as polyethylene oxide (PEO), polypropylene oxide (PPO), polyethylene glycol (PEG) and polyvinyl ether (PVE); polyurethane; melamine resins; gelatin; carrageenan; dextran; gum arabic; casein; pectin; albumin; chitins; chitosans; starch; collagen derivatives; collodion and agar-agar. The most preferred variants for the binder are polyvinyl acetates, ethylvinylacetates, block copolymers based on polyvinylacetate, block copolymers based on polyvinylalcohol, acrylates, latexes, polyvinyl derivaties, VCVAC derivatives, polyurethanes based on polyols and isocyanates, polyurethanes based on polycarbamates and polyaldehydes, e.g. both as a watery dispersion/emulsion or a watery or solvent solution. As stated above preferred binders for the inkjet receiving layer include polyvinyl alcohol (PVA), but according to variants a vinylalcohol copolymer or modified polyvinyl alcohol may be applied. The modified polyvinyl alcohol may be a cationic type polyvinyl alcohol, such as the cationic polyvinyl alcohol grades from Kuraray, such as POVAL C506, POVAL C118 from Nippon Goshei.

Preferably, said paper is provided with 0.2 to 10 g/m², and preferably between 0.5 and 5 g/m², dry coating weight of a binder in said ink receiver layer.

Preferably, the ink receiver coating can comprise also a crosslinking agent for the crosslinking reaction of the binder. The crosslinking agent s preferably selected from the group comprising: aldehydes, polyaldehydes, dialdehydes, alcohols, boronic acid, borax, polyalcohols, carbamates, polycarbamates, carbonic acids, glyoxal based agent, zirconium-based agents, titanates and polycarbonic acids.

The ink receiver coating can further comprise a dispersant. A dispersant is an oligomer or polymer which stabilize the liquid dispersions of pigment against flocculation. The dispersant can comprise polycarboxylates, polyphosphates, a polyionic polymer, preferably polyDADMAC (Polydiallyldimethylammonium chloride) polyamine or alumina salts.

Preferably, the ink receiver coating is provided with less than 10%, more preferably less than 5% based on dry coating weight of dispersant, for example between 5 and 0.1%.

The ink receiver coating can also comprise a flocculant, preferably a metal salt, preferably a cationic metal salt. Preferably said metal salt is chosen from the list consisting of CaCl2, MgCl2, CaBr2, MgBr2, CMA (Calcium Magnesium Acetate), NH4Cl, Calcium Acetate, ZrCl4, calcium nitrate and Magnesium Acetate. The positive ion of the dissolved metal salt will tend to neutralize the electrosteric stabilization function of the pigment. The most preferred cationic metal salts are CaCl2, MgCl2, CMA, Calcium Acetate, calcium nitrate and Magnesium Acetate, as the inventors have obtained the best results with these ink reactive compounds. Said flocculant can also be chosen from the list consisting of sodiumaluminate, a double sulphate salt such as alum, polyaluminumchloride, polyacrylate, dicyandiamide (e.g. Floquat DI5 from SNF) and polyacrylamide. The flocculating agent pulls the ink pigments out of the ink dispersion. Thereby the pigments are prevented from penetration to far down into the ink receiver coating. Mainly the vehicle of the ink, e.g. the water in the case of waterbased inks, is absorbed deeper down into the ink receiver coating.

Preferably, ink receiver coating is provided with 20 to 70%, based on dry coating weight of flocculating agent, in particular of metal salt.

In a particular embodiment the ink receiver coating can be acidic. In particular can comprise one or more acid component. Said acid component can be either organic or inorganic. Preferred examples of acid component are citric acid, formic acid, lactic acid, propionic acid or a combination thereof. Preferably said acid component can show a pH 5, more preferably below 4,5. Said acid component has the function of destabilizing the ink dispersion and is generally used as an alternative to the above mentioned metal salts.

The ink receiver coating may also comprise one or more of the following agents:
Agents altering, more particularly lowering, the pH of said ink receiver coating. Preferably the pH of the ink receiver coating composition is lowered to pH 5 or lower, by selecting the amount and type of said substance, which selection is within the ambit of the skilled man. Preferably said substance is chosen from the list consisting of formic acid, tartaric acid, acetic acid, hydrochloric acid, citric acid, phosphoric acid, sulfuric acid, AlCl₃ and boronic acid. An adjusted, more particularly lowered pH, preferably to pH 5 or less, increases the chemical affinity of the ink receiver coating with the ink and will interfere with the electrosteric stabilization function on the pigment, such that the dispersion of the pigments in the ink will become destabilized quickly.
Particle surface modifying agents or coupling agents: between 0.05 and 5 g/m², preferably between 0.2 and 2 g/m², e.g. chosen from the non-limiting list consisting of amino silanes, ureido silanes, aldehyde silanes, tetraethylorthosilicate, siliazanes, organically modified silanes, organically modified siliazanes, chlorosilanes, organically modified chlorosilanes, bissilanes, organobissilanes, silsesquioxanes, polysilsesquioxnes, silane oligomers, organically modified silane oligomers, bissilane oligomers, organically modified bissilane oligomers, oligomeric silsesquioxanes, and oligomeric polysilsesquioxanes.
Additives: wetting agent between 0.05 and 0.5 g/m²; and/or defoaming agent between 0.05 and 0.5 g/m²; and/or fungicide between 0.05 and 0.5 g/m².

Preferably, said paper or foil is provided with 0.2 to 10 g/m², and preferably between 0.5 and 5 g/m², dry weight of said ink receiver coating.

Preferably the paper layer onto which the ink receiver coating is applied has a base weight of 40 to 130 grams per square meter, e.g. between 60 and 90 grams per square meter.

Preferably, the side of the paper layer unto which the ink receiver coating is to be applied has been smoothened, preferably during its production. The smoothening diminishes the amount of binder penetrating the paper's core, such that the pigments contained therein can be better bound by the available binder substance and variations in absorption may be less. Preferably, the paper obtained using the method of the invention, i.e. including the ink receiver coating, has a Gurley value of between 10 and 60 seconds, and preferably between 12 and 50 seconds. Preferably, the paper layer can show, after application of the ink receiver coating, an increase of the Gurley value of less than 30% more preferably less than 20% based on the initial Gurley value of the uncoated paper layer. Such paper layer results in an excellent printing quality, since the deposited inks tend to bleed less into the paper, and the position accordance, or so-called register, between printed patterns applied with different inkjet heads is more easily attained and maintained. It is to be noted that the above indicated Gurley value of the coated paper layer is definitely lower than other coated paper layer, especially than those of paper layers coated with coating comprising silica and binder, in particular high quantity of crosslinked binder. Such a low Gurley value improves the resin impregnation capability of the paper layer, so that said paper layer are particularly suitable in use for decoration of panels, like for furniture or floor panels where the decorative paper is impregnated with melamine resin before lamination onto a supporting board. The paper layer comprising the ink receiver coating shows a resin penetration time lower than 3 sec.

Preferably, the paper layer of the invention is opaque and/or contains titanium oxide as a whitening agent.

Preferably, in the method of the invention, the paper is intended to be printed using waterbased inks or UV curing inks or hydro-UV inks, in particular comprising pigmented inks. In the first place the papers obtained through the method of the first aspect are intended to be printed upon using inkjet printing equipment. However, the inventors have also found enhanced printing quality with the use of thus treated papers in analog printing equipment.

According to the most preferred embodiment said ink receiver coating is applied in one step in order to form a unique layer having the inkjet receiving coating composition. Anyway, it is not excluded that said ink receiver coating is applied in at least two partial steps, wherein respectively a first layer with a first composition and, subsequently, a second layer is applied with a second composition wherein said first and second composition may be either the same or different compositions.

Preferably, a paper obtained with the method of the invention is provided with thermosetting resin, such as melamine resin, preferably after providing it with a printed pattern by means of inkjet printing. For this reason, the paper layer is only provided with an ink receiver coating at one side thereof, namely at the side provided to be printed upon. The other, opposite, side, is preferably untreated, such that this opposite side shows the original porosity of the paper layer from which it is started. The resin may then be provided substantially from the bottom side into the papers core. To allow sufficient impregnation of the paper having the inkjet receiving coating, the speed of the impregnation channel may be tuned down, the resin may be made less viscous, the impregnation may be pressurized and/or the resin may be heated, e.g. to between 30 and 50° C.

Generally, it is noted that, although the paper obtained with the method of the invention is printable with an inkjet printer, it is not excluded that the paper or foil eventually is printed using other techniques, such as rotogravure or flexo printing.

Preferably, said ink receiving coating is a liquid substance which is deposited on said paper layer, and which is preferably forcibly dried e.g. in a hot air oven or by means of infrared or near infrared light or by means of microwave drying. Preferably the liquid substance is a water-based suspension of at least said binder, and possibly said pigments. Preferably the liquid substance composition has a dry matter content of 4 to 65 percent by weight of the liquid substance.

The deposition of said liquid substance of the ink receiver coating can be obtained in any way, possibly by means of printing, e.g. inkjet printing, but preferably by means of coating techniques, such as roller coating, e.g. by means of one or more gravure rollers, spraying, metering rollers, bead coating, scattering, slot die coating. With the latter techniques, preferably a coating is obtained that covers at least 80% of the surface of the paper layer or foil. Inline measurement systems may be desirable to steer and control the weight of the ink receiver coating. Such technique brings down the risk of obtaining uncoated areas of the paper, which could lead to local flaws in the printed pattern. A preferred equipment for application of the liquid substance is a rotogravure or anilox coating device.

The deposition of the liquid substance for the ink receiving coating may be performed in a rotogravure coating line or, alternatively, on the printing equipment, immediately before the printing operation. This last case solves any possible issues with limited shelf life of the ink receiver coating. Preferably the deposition of the liquid substance is performed while the paper or foil is still in an “endless” shape, namely taken from the roll without cutting. Such techniques allow for a more uniform application of the ink receiver coating. In the case the coating is wholly or partially done on the printing equipment, the printing equipment is preferably a roll-to-roll or a roll-to-sheet printer, comprising a coating device upstream of the print heads, for example a gravure coater and/or additional printing heads suitable for printing the liquid substance for the respective sublayer of the ink receiver coating. Such additional printing heads, for example an additional row of printing heads, may have nozzles with a larger diameter than those used for the actual printing of the pattern. A resolution of 1 to 100, or even 1 to 25 dots per inch may suffice for these nozzles.

It is also possible that the ink receiver coating may be applied directly in line with the paper machine with a size press or even more preferable a film press.

Said liquid substance for said ink receiver coating preferably shows a viscosity of 10 to 75 seconds Din cup 4 at 20° C. Such property allows for a straightforward application of the liquid substance to the surface of the paper layer or foil. In experiments, a solid content of about 12% and viscosity of about 20 seconds yielded a sufficiently uniform coating on a previously untreated paper layer, e.g. when applied by means of a roller coater.

It is to be noted that the present invention also relates to an ink receiver coating composition having the features described in relation to the first independent aspect. Thereto with the same aim as in said first aspect, according to a second independent aspect, the invention also relates to an ink receiver coating composition for printing paper, at least an ink adhesion promoter. The composition of the second independent aspect can comprise one or more of the features described in relation to the first independent aspect.

Further, it is to be noted that the present invention also relates to paper layers that are obtained using the methods of the first aspect of the present invention. With the same aim as in said first aspect, according to a third independent aspect, the invention also relates to a paper for inkjet printing, wherein said paper at least at one side is provided with an ink receiver coating, with as a characteristic that ink receiver coating is provided with an ink adhesion promoter.

It is to be noted that said paper can comprise one or more of the features described above in relation to the first independent aspect.

The invention further, relates to a method for manufacturing a printed décor paper for laminate panel wherein said paper is provided with said ink adhesion promoter. Thereto the present invention according to its fourth independent aspect relates to a method for manufacturing a printed décor paper for laminate panel, wherein the method comprises the steps of: providing a printable paper, printing a décor on said paper. Wherein said method comprises the step of providing said paper with an ink adhesion promoter. The ink adhesion promoter can be provided according to two main variants which are here below described.

According to the first variant of the method of the fourth aspect, said ink adhesion promoter is provided before said printing step.

In a first preferred possibility, of said first variant, this is obtained by providing a printable paper according to the third aspect or manufactured according to the method of the first aspect. This first possibility of the first variant provide the advantage that the method for manufacturing the décor paper doesn't require any further step or any modification to an existing décor paper manufacturing line.

In a second less preferred possibility of said first variant, the step of providing the ink adhesion promoter can be performed after said step of providing the printable paper. The ink adhesion promoter can be provided in form of a coating on top of the printable paper, for example on top of the ink receiving coating thereof. In this way the method for manufacturing the printed paper can start with any printable paper.

According to the second variant of the method of the fourth aspect, said ink adhesion promoter is provided after said printing step. Thereto the ink adhesion promoter can be provided in form of a coating on top of the printed paper, more in detail above of a printed pattern provided on the paper. In this way the method for manufacturing the printed paper can start with any printable paper and by providing the ink adhesion promoter after printing, the ink adhesion promoter doesn't affect the printability of the printable paper and the quality of the print.

Preferably, in said second variant the ink adhesion promoter coating is transparent or translucent. The ink adhesion promoter coating can also comprise a binder, preferably polyvinyl alcohol. Said binder can have one or more of the characteristics described above in relation to the binder of the ink receiver layer.

The ink adhesion promoter can be coated on top of said paper in liquid form in both said first and second variant. The deposition of sink adhesion promoter can be obtained in any way, possibly by means of printing, e.g. inkjet printing, but preferably by means of coating techniques, such as roller coating, e.g. by means of one or more gravure rollers, spraying, metering rollers, bead coating, scattering, slot die coating.

After being provided said ink adhesion promoter coating can be dried, preferably forcibly dried e.g. in a hot air oven or by means of infrared or near infrared light or by means of microwave drying. In some embodiment the ink adhesion promoter and/or the binder in the ink adhesion promoter coating can be curable, preferably radiation curable for example UV or EB curable. In such a case the method can comprise the step of curing the ink adhesion promoter coating preferably by irradiation.

Preferably, in said fourth aspect, the paper is printed by means of an inkjet printer. Preferably, said inkjet printer operates on the basis of waterbased inks, wherein, more particularly, an inkjet printer of the single-pass type and/or an inkjet printer operated in single-pass mode is preferred.

Preferably the printed pattern applied to the paper layer of the invention, covers the majority, and preferably 50 percent or more of the surface of said paper layer

Preferably the ink comprises a binder. In the most preferred embodiment said binder in the ink and the ink adhesion promoter are the substantially the same. With substantially the same it is meant that the ink adhesion promoter can be the same substance of the binder of the ink, or can belong the same family of substances. Preferably the binder of the ink can comprise urea-based binder, polyurethane-based binder, casein-based binder, styrene-based binder, polyester-based binder, polyvinyl-based binder, alkyd-based binder, ketone-based binder, melamine-based binder, silicone-based binder, cellulose-based binder, gum-based binder, acrylic-based binder or a mixture or copolymer thereof.

Preferably, for printing said printed pattern use is made of pigment containing ink, wherein for said pigment containing ink use can be made of a waterbased or so-called aqueous ink. The dry weight of the total volume of said pigment containing inks deposited on said paper layer can be below 12 grams per square meter or lower, preferably 3 to 4 grams per square meter or lower. The limitation of the dry weight of the applied ink leads to a layer of ink that lowers the risk of pressing defects and splitting in the top layer. Indeed, possible interference between the ink layer and the thermosetting resin during the pressing operation is further reduced. Because the ink load is limited to a maximum of 12 grams per square meter, wrinkling or expansion of the paper due to the ink can be brought to an acceptable level, which assures stable further processing. Preferably said pigments of said pigment containing ink have an average particle size of less than 300 μm. Preferably the printed pattern is entirely, or at least essentially, made up of such pigmented ink. Preferably said total volume of deposited pigment containing ink is less than 15 milliliters, or even better less than 10 milliliter or still less, e.g. 5 milliliter or less per square meter.

Preferably for printing the paper layer or foil of the invention, a digital inkjet printer is applied that allows to jet ink droplets with a volume of less than 50 picoliters. The inventors have found that working with droplets having a volume of 15 picoliters or less, for example of 10 picoliters, brings considerable advantages regarding the limitation of dry weight of deposited inks. Preferably a digital inkjet printer is applied that allows to work with ink droplets of several volumes in one and the same print, or with so-called halftone or gray scale. The possibility of half tone or gray scale printing enables further limitation of the dry weight of deposited ink while maintaining an excellent print definition. Preferably a digital inkjet printer is applied that allows to attain a definition of at least 200 dpi, or even better at least 300 dpi (dots per inch).

It is further clear that the décor paper obtained in the fourth aspect of the invention is suitable for use as a decor paper in a method for manufacturing floor panels, furniture panels, ceiling panels and/or wall panels. Said panel at least comprises a substrate material and a provided thereon top layer with a printed decor, wherein said top layer is substantially formed from thermosetting resin and one or more paper layers, wherein said paper layers comprise a decor paper on the basis of a printable paper in accordance with the third independent aspect and/or obtained by means of a method in accordance with the first independent aspect and/or the preferred embodiments of these aspects.

Preferably the décor paper is, after printing, provided with an amount of thermosetting resin equaling 40 to 250% dry weight of resin as compared to weight of the paper. Experiments have shown that this range of applied resin provides for a sufficient impregnation of the paper, that avoids splitting to a large extent, and that stabilizes the dimension of the paper to a high degree.

Preferably the décor paper is, after printing, provided with such an amount of thermosetting resin, that at least the paper core is satisfied with the resin. Such satisfaction can be reached when an amount of resin is provided that corresponds to at least 1.5 or at least 2 times the paper weight.

Preferably, the obtained resin provided paper layer, i.e. after provision of the thermosetting resin, has a relative humidity lower than 15%, and still better of 10% by weight or lower.

In general, the paper and ink receiver coating, whether provided with resin or not, has a relative humidity lower than 15%, and still better of 8% by weight or lower while printing.

Preferably the step of providing said paper layer with thermosetting resin involves applying a mixture of water and the resin on said paper layer. The application of said mixture might involve immersion of the paper layer in a bath of said mixture and/or spraying, jetting or otherwise coating said mixture on said paper. Preferably the resin is provided in a dosed manner, for example by using one or more squeezing rollers and/or doctor blades to set the amount of resin added to the decor paper.

Preferably said thermosetting resin is a melamine-based resin, more particularly a melamine formaldehyde resin with a formaldehyde to melamine ratio of 1.4 to 2. Such melamine-based resin is a resin that polycondensates while exposed to heat in a pressing operation. The polycondensation reaction creates water as a by-product.

Preferably the paper layer is only impregnated with resin printing and after application of the ink adhesion promoter. In this way bleeding of the ink is prevented by the ink adhesion promoter.

The method of the fifth aspect of the invention preferably comprises the step of hot pressing the printed and resin provided decor paper, at least to cure the resin of the obtained resin provided decor paper. Preferably the method of the invention forms part of a DPL process as above described, wherein the printed resin provided paper layer of the invention is taken up in the stack to be pressed as the decorative layer. It is of course not excluded that the method of the invention would form part of a CPL (Compact Laminate) or an HPL (High Pressure Laminate) process in which the decorative layer is hot pressed at least with a plurality of resin impregnated core paper layers, e.g. of so called Kraft paper, forming a substrate underneath the decorative layer, and wherein the obtained pressed and cured laminate layer, or laminate board is, in the case of an HPL, glued to a further substrate, such as to a particle board or an MDF or HDF board.

The method may further comprise the step of providing the top layer of the laminate panel with a wear layer. Preferably a further resin layer is applied above the decor paper after printing, e.g. by way of an overlay, i.e. a resin provided carrier layer, or a liquid coating, preferably while the decor layer is laying on the substrate, either loosely or already connected or adhered thereto. The ink adhesion promoter, in this case, may reduce the risk of ink bleeding also during the lamination of the wear layer.

Preferably, the method of the fifth aspect of the invention further comprises the step of applying a counter layer or balancing layer at the surface of the substrate opposite the top layer. The counter layer or balancing layer preferably comprises a paper layer and thermosetting resin, preferably the same resin as the top layer.

Preferably the mutual adherence of the substrate, the possible counter layer and the possible transparent or translucent layer is obtained in one and the same press treatment. According to the most preferred embodiment of the fifth aspect, these steps are taken up in a DPL process.

It is clear that the decor paper, the substrates, the paper layers mentioned above may have to be divided during the methods of the invention for obtaining their respective final dimensions. The panels obtained by means of a DPL press treatment or similar are preferably sawn or otherwise divided. Other treatments of the obtained panels are of course not excluded.

### BRIEF DESCRIPTION OF THE DRAWINGS

With the intention of better showing the characteristics according to the invention, in the following, as an example without limitative character, an embodiment is described, with reference to the accompanying drawings, wherein:

FIG. 1 schematically shows an embodiment of a paper layer that has been provided with an inkjet receiving coating in accordance with a preferred embodiment of the method of the first aspect of the invention;

FIG. 2 on a larger scale provides a view on the area F2 illustrated in FIG. 1;

FIG. 3 shows a piece of equipment for use amongst others in the first aspect of the invention;

FIG. 4 schematically shows a side view of a printer operated in single-pass mode on a central cylinder;

FIG. 5 schematically shows an embodiment of a printed décor paper obtained according to a second variant of the method of the fourth aspect of the invention;

FIG. 6 on a larger scale provides a view of the area F6 illustrated in FIG. 5;

FIG. 7 shows some steps in a method according to the fourth aspect of the invention;

FIG. 8 shows some steps of an embodiment of a method for manufacturing laminate panels according to the fifth aspect of the invention;

FIG. 9 shows in perspective a panel obtained by the method of FIG. 8; and

FIG. 10 is a cross-section view taken along the line X-X shown in FIG. 9.

### DESCRIPTION ON NON-LIMITING EMBODIMENTS

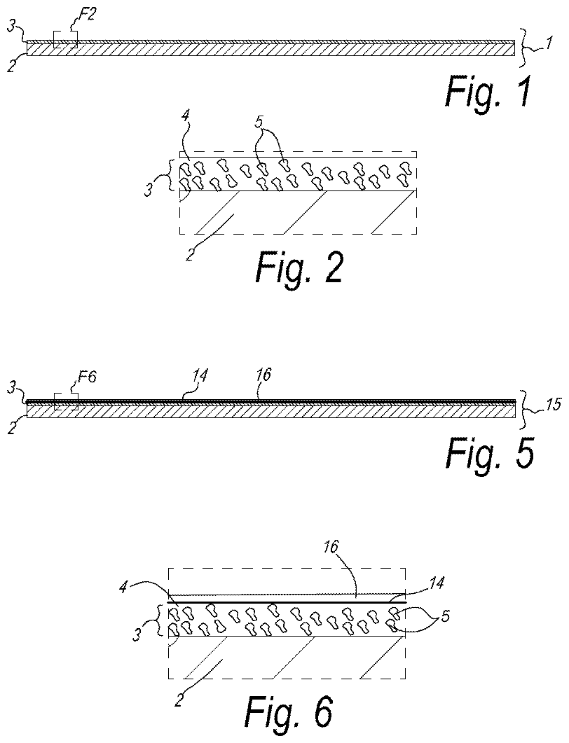

FIG. 1 schematically illustrates a printable paper 1. The printable paper 1 comprises a paper sheet 2 provided with an ink receiver coating 3. The paper sheet 2 is, in this case, a base printing paper having a weight of about 70 grams per square meter and with a mean air resistance as expressed by Gurley value of between 10 and 30 seconds.

It is generally noted that the dimensions of the represented paper sheet 2 and the ink receiver coating 3 is, in the figures, drawn out of scale in order to better illustrate the invention.

FIG. 2 shows that the ink receiver coating 3 comprises a binder 4 and a pigment 5. In the preferred embodiment the pigment comprises silica particles. The ink receiver coating 3, further comprises an ink reactive compound, more particularly a flocculating agent and/or a dispersant, such in accordance with the first aspect of the invention. It is clear however that the figures are also illustrative for many aspects of the present invention in the cases where an ink reactive compound, more specifically an ink destabilizing agent, other than a flocculating agent has been applied, such as for example a cationic metal salt.

The ink receiver coating 3 of the example comprises an ink adhesion promoter, preferably selected from the group comprising: urea-based promoter, polyurethane-based promoter, casein-based promoter, styrene-based promoter, polyester-based promoter, polyvinyl-based promoter, alkyd-based promoter, ketone-based promoter, melamine-based promoter, silicone-based promoter, cellulose-based promoter, gum-based promoter, acrylic-based promoter or a mixture or copolymer thereof.

The ink adhesion promoter is present on the printable paper 1 in a quantity of 4 g/sqm on a dry basis.

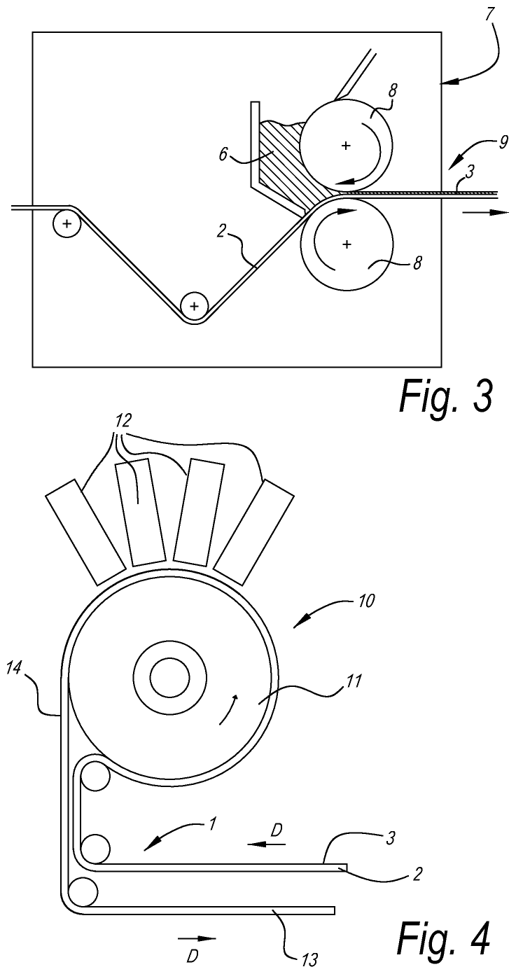

FIG. 3 shows that, in accordance with a preferred embodiment of the first aspect of the invention, the ink receiver coating 3, may be obtained by coating a liquid substance 6 to the paper sheet 2. A device 7 comprising reverse metering rollers 8 is applied. Such device 7 may initially apply an excess of the liquid substance 6, which is squeezed off to the desired weight by means of the rollers 8, which also may provide for a smooth coating surface. Preferably, the obtained half product 9 is then dried, e.g. by means of a hot air oven, to reach a residual humidity level of preferably below 10%, or of about 7%. Such is here not illustrated, but this may be executed in a fairly similar way. It is clear that as an alternative to the device 7, other application techniques may be used, such as application by one or more gravure rollers, possibly also running in reverse, or with a size press or a film press, preferably in line with the paper machine. Wherein with paper machine is meant the line for the production of the paper. For example said device 7 can be a film press that applies the ink receiver coating 3 between two drying steps on the machine paper.

FIG. 4 illustrates a step in a method for manufacturing a décor paper in accordance to a first variant of the fourth independent aspect of the invention. The printable paper layer 1 having the ink receiver coating 3 obtained according to the first aspect of the invention may be printed by means of an inkjet printer 10, which, in this example comprises a central cylinder 11 upon which the printable paper layer 1 is partially wound and several printing units 12, each comprising one or more print heads, are disposed radially around the central cylinder 11 and over the area of the paper layer 1 to be printed. For example, the central cylinder 11 of the inkjet printer 10 comprises a radius between 800 and 950 mm, for example around 880 mm, and comprises a web angle above 270°, for example above 300°, preferably 320°. The printer 10, in this example, relates to a printer of the single pass type, wherein the provision of the printed pattern involves a relative motion of said printable paper 1 relative to said inkjet printer 10, more particularly to the printing unit 12, during printing in a printing direction D. In this case, the printing unit 12 and the print heads are at standstill, while the paper layer 1 moves during ejection of inks onto the paper layer 1, more precisely onto the ink receiver coating 3 comprising the ink adhesion promoter applied to the paper sheet 2. The paper layer 1 gets printed during a single continuous movement of the paper layer 1 relative the printer 10. The obtained décor paper 13 comprises a printed pattern or ink layer 14 on top of the ink receiver coating 3.

FIGS. 5 and 6 show a printed décor paper 15 obtained according to a second variant of the method of the fourth aspect of the invention. The décor paper 15 comprises the paper sheet 2 and the ink receiving coating 3. In this case the ink receiver coating is preferably free from the ink adhesion promoter agent, although it is not excluded that the ink receiver coating comprises the ink adhesion promoter. The décor paper 15 further comprises the printed pattern or ink layer 14 on top of the ink receiver coating 3.

The décor paper 15 comprises an ink adhesion promoter coating 16, preferably transparent, provided on top of said printed pattern or ink layer 14. The ink adhesion promoter coating 16 comprises an ink adhesion promoter preferably selected in the group comprising; urea-based promoter, polyurethane-based promoter, casein-based promoter, styrene-based promoter, polyester-based promoter, polyvinyl-based promoter, alkyd-based promoter, ketone-based promoter, melamine-based promoter, silicone-based promoter, cellulose-based promoter, gum-based promoter, acrylic-based promoter or a mixture or copolymer thereof. The ink adhesion promoter coating 16 can also comprise a binder, preferably polyvinyl alcohol.

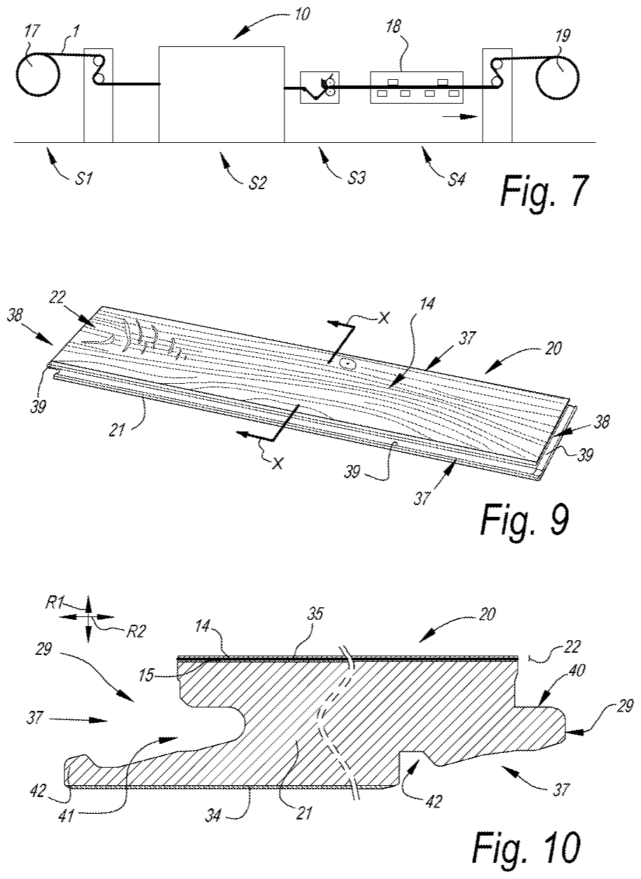

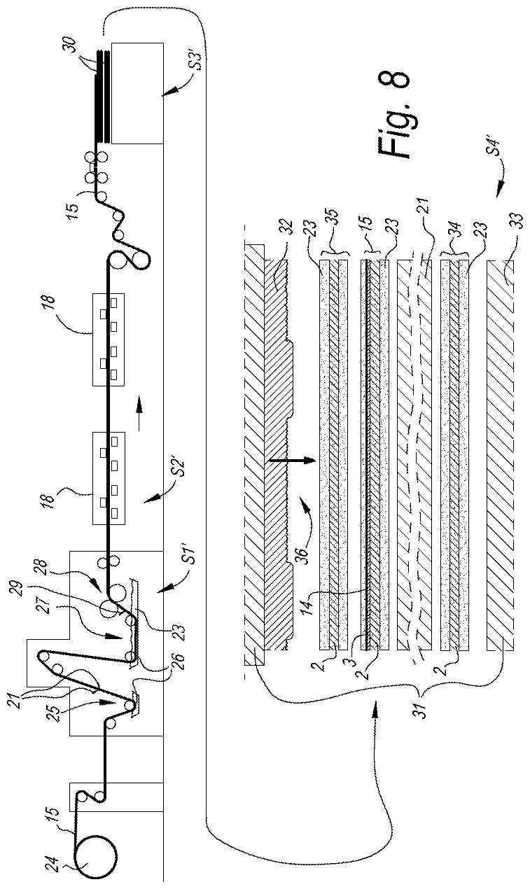

Some steps of this second variant of the method for obtaining the printed décor paper 15 of FIGS. 5 and 6 are illustrated in FIG. 7. The method of the example comprises at least the step S1 of providing a printable paper 1, having the inkjet receiving layer 3, from a first roll 17 to an inkjet printer 10. The inkjet printer 10 performs a step S2 of printing the printed pattern on top of the printable paper 1, preferably in the same way described in relation to FIG. 4. The method further comprises a step S3 of coating the ink adhesion promoter coating 16 on top of the printed pattern 14. In the illustrated example, ink adhesion promoter coating 16 is provided in form of a liquid substance and is applied with the same device 7 described in relation to FIG. 3. The method illustrated in FIG. 7 comprises the step S4 of drying the décor paper 15 In the example hot air ovens 18 are used, but alternatively other heating equipment can be used, such as microwave or infrared drying equipment. The obtained décor paper 15 is then rolled up on a second roll 19 and is ready to be used in a method for manufacturing panels as illustrate in FIG. 8.

FIG. 8 illustrates some steps of a method for manufacturing laminate panels 20 of the type shown in FIG. 9. The method forms an illustration of the fifth independent aspect of the invention as described in the introduction of the present patent application.

The obtained decorative panels 20 at least comprise a substrate 21 and a top layer 22. The top layer 22 comprises a décor paper 15, manufactured in accordance with the fourth aspect of the invention, and provided with a printed pattern 13 representing a wood pattern, as is the case here. The décor paper 15 comprises the ink adhesion promoter either in the ink receiver coating 3 or in the ink adhesion promoter coating 16.

The method of the example embodiment comprises at least the step S1′ of providing said décor paper 15 with thermosetting resin 23. Hereto the décor paper 15 is taken from a roll 24 and transported to a first impregnation station 25 where said décor paper 15 is immersed in a bath 26 of said resin 23, more particularly a mixture of water and resin 23. The décor paper 15 is then allowed to rest while in this case being transported upwards. The resting allows for the resin 23 to penetrate the paper core. The décor paper 15 then comes into a second impregnation station 27 where the décor paper 15 is, in this case, again immersed in a bath 26 of resin 23, more particularly a mixture of water and resin 23. A set of squeezing rollers 28 allows to dose the amount of resin 23 applied to the décor paper 15. In the example several doctor blades 29 are available for partially removing resin 23 at the surface of the resin provided décor paper 15.

In a second step S2′ the resin provided décor paper is dried and its residual humidity level is brought to below 10%. In the example hot air ovens 18 are used, but alternatively other heating equipment can be used, such as microwave or infrared drying equipment.

FIG. 8 also illustrates that the continuous décor paper 15 is cut to sheets 30 and stacked in a step S3′.

FIG. 8 further illustrates that in a subsequent step S4′ the obtained sheets 30 or the décor paper 15 is taken up in a stack to be pressed in a short daylight press 31 between upper and lower press plates 32-33. Said stack comprises from bottom to top a counter layer 34, a plate shaped substrate 21, the abovementioned décor paper 15 and a protective layer 35, wherein the counter layer 34 and the protective layer 35 both comprise a paper sheet 2 and resin 23. The stack is then pressed and the press treatment results in a mutual connection between the constituent layers 15-21-34-35, including the substrate 21, of the stack, as well as in a hardening or curing of the available resin 23. More particularly here a polycondensation reaction of the melamine formaldehyde resin 23 takes place, having water as a by-product.

The upper press plate 32 is a structured press plates that provides a relief in the melamine surface of the panel 20 during the same press treatment of the step S4′, by bringing the structured surface 36 of the upper press plate 32 into contact with the melamine of the protective layer 35.

FIG. 9 illustrate that the obtained decorative panel or laminate panel 20 can have the shape of a rectangular and oblong laminate floor panel, with a pair of long sides 37 and a pair of short sides 38 and having an HDF or MDF substrate 21. In this case the panel 20 is provided at least at the long sides 37 with coupling means 39 allowing to lock the respective long sides 37 together with the sides of a similar panel both in a direction R1 perpendicular to the plane of the coupled panels, as in a direction R2 perpendicular to the coupled sides and in the plane of the coupled panels. As illustrated in FIG. 10 such coupling means or coupling parts can basically have the shape of a tongue 40 and a groove 41, provided with additional cooperating locking means 42 allowing for said locking in the direction R2.

The invention is further disclosed by the following paragraph list as defined by the below numbered paragraphs.

1—A method for manufacturing paper printable with an inkjet printer and/or analog printing, preferably gravure printing for use as a decor paper in a laminate panel, wherein the method at least comprises the following steps:
the step of providing a paper layer;
the step of coating at least one side of said paper layer with an ink receiver coating;
wherein the method comprises the step of providing said paper with an ink adhesion promoter.
   2—The method of item 1, wherein said ink adhesion promoter is provided in the ink receiver layer.
   3—The method of item 1 or 2, wherein said ink adhesion promoter comprises urea-based promoter, polyurethane-based promoter, casein-based promoter, styrene-based promoter, polyester-based promoter, polyvinyl-based promoter, alkyd-based promoter, ketone-based promoter, melamine-based promoter, silicone-based promoter, cellulose-based promoter, gum-based promoter, acrylic-based promoter or a mixture or copolymer thereof.
   4—The method according to any of the preceding items, wherein said ink adhesion promoter is provided in an amount above 0.2 g/sqm, more preferably above 1 g/sqm.
   5—The method according to any of the preceding items, wherein said ink adhesion promoter is provided in an amount below 10 g/sqm, more preferably below 5 g/sqm
   6—The method according to any of the preceding items, wherein the ink receiver layer comprises at least a pigment and/or a binder.
   7—The method according to item 6, wherein the pigment comprises silica.
   8—The method according to item 6 or 7, wherein the binder comprises poly-vinyl alcohol.
   9—A printable paper comprising a paper layer and an ink receiver coating, wherein it comprises a ink adhesion promoter, preferably obtained via the method according to any of the preceding items.
   10—The printable paper of item 9, wherein said ink adhesion promoter is provided in the ink receiver layer.
   11—The printable paper of item 9 or 10, wherein said ink adhesion promoter comprises urea-based promoter, polyurethane-based promoter, casein-based promoter, styrene-based promoter, polyester-based promoter, polyvinyl-based promoter, alkyd-based promoter, ketone-based promoter, melamine-based promoter, silicone-based promoter, cellulose-based promoter, gum-based promoter, acrylic-based promoter or a mixture or copolymer thereof.
   12—A décor paper for use in a laminate panel comprising a paper layer according to any of the items from 9 to 1 and a printed décor.
   13—A décor paper for use in a laminate panel comprising a paper layer, preferably an ink receiver layer, a printed décor and an ink adhesion promoter coating above said printed décor.
   14—A method for manufacturing a décor paper for use as a decor paper in a laminate panel, comprising the steps of:
providing a printable paper layer,
providing a printed décor on top of said printable paper layer, preferably via inkjet printing, wherein the printable paper layer is according to any of the items from 9 to 11, or in that the method comprises the step of providing an ink adhesion promoter coating on top of said printed décor.
   15—The method according to item 14, wherein said décor is obtained by printing an ink, said ink comprising a binder and wherein said binder and said ink adhesion promoter are substantially the same.
   16—The method according to item 15, wherein binder of the ink can comprise urea-based binder, polyurethane-based binder, casein-based binder, styrene-based binder, polyester-based binder, polyvinyl-based binder, alkyd-based binder, ketone-based binder, melamine-based binder, silicone-based binder, cellulose-based binder, gum-based binder, acrylic-based binder or a mixture or copolymer thereof
   17—A method for manufacturing a laminate panel, preferably a floor, wall, furniture or ceiling panel, of the type comprising a substrate and a top layer, wherein said top layer comprises at least a decorative layer having a décor paper, comprising the steps of:
providing a décor paper according to item 12 or 13,
impregnating said décor paper with a resin, preferably a thermosetting melamine resin,
laminating, preferably via heat and pressure, said impregnated décor paper on top of a substrate, preferably made of a wood-based material.
   18—An ink receiver layer composition for printable décor paper comprising at least an ink adhesion promoter, preferably selected in the group comprising: urea-based promoter, polyurethane-based promoter, casein-based promoter, styrene-based promoter, polyester-based promoter, polyvinyl-based promoter, alkyd-based promoter, ketone-based promoter, melamine-based promoter, silicone-based promoter, cellulose-based promoter, gum-based promoter, acrylic-based promoter or a mixture or copolymer thereof.
   19—The ink receiver layer composition according to item 18, wherein it comprises at least a pigment and/or a binder.

The present invention is in no way limited to the above described embodiments, but it may be realized according to several variants without leaving the scope of the invention.

1. A method for manufacturing paper printable with an inkjet printer and/or analog printing for use as a decor paper in a laminate panel, the method comprising:
providing a paper layer;
coating at least one side of the paper layer with an ink receiver coating; and
the paper layer with an ink adhesion promoter.

2. The method of claim 1, wherein the ink adhesion promoter is provided in the ink receiver coating.

3. The method of claim 1, wherein the ink adhesion promoter comprises urea-based promoter, polyurethane-based promoter, casein-based promoter, styrene-based promoter, polyester-based promoter, polyvinyl-based promoter, alkyd-based promoter, ketone-based promoter, melamine-based promoter, silicone-based promoter, cellulose-based promoter, gum-based promoter, acrylic-based promoter or a mixture or a copolymer thereof.

4. The method according to claim 1, wherein the ink adhesion promoter is provided in an amount above 0.2 g/sqm.

5. The method according to claim 1, wherein the ink receiver coating comprises at least a pigment and/or a binder.

6. The method according to claim 5, wherein the pigment comprises silica.

7. The method according to claim 5, wherein the binder comprises poly-vinyl alcohol.

8. A printable paper obtained according to the method of claim 1.

9. The printable paper of claim 8, wherein the ink adhesion promoter is provided in the ink receiver coating.

10. The printable paper of claim 8, wherein the ink adhesion promoter comprises urea-based promoter, polyurethane-based promoter, casein-based promoter, styrene-based promoter, polyester-based promoter, polyvinyl-based promoter, alkyd-based promoter, ketone-based promoter, melamine-based promoter, silicone-based promoter, cellulose-based promoter, gum-based promoter, acrylic-based promoter or a mixture or a copolymer thereof.

11. A décor paper for use in a laminate panel comprising:
a printable paper according to claim 8; and
a printed décor.

12. A décor paper for use in a laminate panel comprising:
a paper layer;
an ink receiver layer;
a printed décor; and
an ink adhesion promoter coating above the printed décor.

13. A method for manufacturing a décor paper for use in a laminate panel, the method comprising:
providing a printable paper layer;
providing a printed décor on top of the printable paper layer;
wherein the printable paper is according to claim 8, or wherein the method further comprises providing an ink adhesion promoter coating on top of the printed décor.

14. The method according to claim 13, wherein the printed décor is obtained by printing an ink that includes a binder; and
wherein the binder and the ink adhesion promoter are substantially the same.

15. A method for manufacturing a laminate panel of the type having a substrate and a top layer, the top layer including at least a decorative layer having a décor paper, the method comprising:
providing a décor paper according to claim 11;
impregnating the décor paper with a resin; and
laminating the impregnated décor paper on top of a substrate.
